(19) United States
(12) Patent Application Publication
(10) Pub. No.: US 2009/0193249 A1
(43) Pub. Date: Jul. 30, 2009

(54) PRIVACY-PRESERVING INFORMATION DISTRIBUTION SYSTEM

(75) Inventors: Claudine Viegas Conrado, Eindhoven (NL); Milan Petkovic, Eindhoven (NL); Willem Jonker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,692

(22) PCT Filed: May 24, 2005
(86) PCT No.: PCT/IB2005/051679

§ 371 Date: Nov. 28, 2006

(30) Foreign Application Priority Data
May 28, 2004 (EP) 04102378.9

(51) Int. Cl. H04L 29/06; H04L 9/32

(52) U.S. Cl. 713/156; 726/6

(57) ABSTRACT

A system, device and method for keeping the identity of a user secret, while managing requests for information, in an information distribution system. The identity of the user is kept secret by the use of a persistent pseudonym and a temporary pseudonym, which are associated with a user identity device. The process of information distribution is enhanced by the use of licenses and certificates, which the user obtains by representing himself with the permanent pseudonym. When accessing the requested information, the user is represented by the temporary pseudonym.

The present invention relates to information distribution systems, wherein users can request digital information, and more particularly to information distribution systems protecting user information.

At the present time, an individual is required to reveal his identity when engaging in a wide range of activities. Typically, when he uses a credit card, makes a telephone call, pays his taxes, subscribes to a magazine or buys something over the internet using a credit or debit card, an identifiable record of each transaction is created and recorded in a computer database somewhere. In order to obtain a service or make a purchase, using something else than cash, organizations require that he identifies himself.

Consumer polls have repeatedly shown that individuals value their privacy and are concerned about the fact that so much personal information is routinely stored in computer databases over which they have no control. Protecting one's identity goes hand in hand with the option to remain anonymous, a key component of privacy. While advances in information and communications technology have fueled the ability of organizations to store massive amount of personal data, this has increasingly jeopardized the privacy of those whose information is being collected. In an increasingly privacy-aware world, disclosure of personal information and possibilities of user tracking, may create a number of privacy concerns on the users' side and eventually, perhaps, even an increased animosity new technologies that are privacy invasive on the part of those users.

This is in glaring contrast to the interest of the service providers or information distributors, who want to know as much about their users as possible, in order to be able to perform as directed marketing campaigns as possible, to protect themselves against fraud, etc. As a measure of precaution, a user who has misused the systems must be precluded from the system in the future.

In many information distribution systems it is relatively easy to learn the habits of different users, for example by tapping the communication within the system. This information can later be misused, for example for spamming. Today these problems are partially solved by, for example, urging the users to pay close attention to how they store for example their secret codes used in the system, or by protecting valuable information by a high degree of security. US 2003/0200468 A1 describes how to preserve the customer identities in on-line transactions, by storing the user's identity at a trusted web site.

However, the above-mentioned system, using a secure web site is vulnerable. Someone who succeeds in attacking the trusted web site, possesses the knowledge of which keys correspond to which user identity. The attacker can then use this information to map the habits of a certain user, in the less protected information distribution system.

It is an object of the present invention to eliminate, or at least alleviate, the described problems of providing privacy for a user of an information distribution system. This object is achieved by a method and a device in accordance with the appended claims 1, 10 and 17. Preferred embodiments are defined in the dependent claims.

The invention is based on an insight that by providing the user with two pseudonyms and continuously updating one of them, it is possible to obtain an information distribution system, wherein there is no link between the actual identity of the user and the information requested by said user. Further, this information distribution system can be as secure as normal information distribution systems acting e.g. in accordance with DRM-rules. As used herein the term “the actual identity of a user” refers to the physical identity of a user or data which can be linked to the physical user, such as a telephone number, an address, a social security or insurance number, a bank account number, a credit card number, an organization number or the like. Further, as used herein, a “pseudonym” or an additional identity is any data, anonymous enough to prevent it from being linked to the actual identity of a person. That there is no link between the actual identity of a user and the information requested by said user, means that there is no obvious way to reconstruct which actual user has requested what information, for example because there are no databases storing information that would enable such a reconstruction.

Thus, according to a first aspect thereof, the present invention provides a method in which the user, being represented by a persistent pseudonym, requests information from an information distributing device. The user presents himself to the information distribution system, using a user identity device to which the persistent pseudonym is associated. The information distribution system verifies, at an identity managing device, that the persistent pseudonym is trusted. Thereafter, if the verification was successful, a temporary pseudonym is associated with said user identity device. Finally, the user is represented by said temporary pseudonym when accessing said requested information obtained from said information distributing device.

According to a second aspect thereof, the present invention provides a user identity device, intended to be used in an information distribution system where the identity of a user is kept secret. Said device comprises a persistent pseudonym and means arranged to send said persistent pseudonym to an identity managing device, belonging to said information distribution system. Further, said device comprises means arranged to send said temporary pseudonym to an accessing device, belonging to said information distribution system.

According to a third aspect thereof, the present invention provides an information distribution system for keeping the identity of a user secret. The system comprises an information distributing device, which is arranged as described in relation to said second aspect of the invention. Further, the system comprises an identity managing device, which is arranged to receive data representing a persistent pseudonym, which is associated with the user identity device. The identity managing device is further arranged to verify that the persistent pseudonym is trusted, and, finally, is arranged to create a temporary pseudonym if said verification was successful.

The information distribution system further comprises means for associating data, which represents said temporary pseudonym, with said user identity device. Finally, the system comprises an accessing device, which is arranged to receive said data representing said temporary pseudonym, and arranged to provide said user access to said requested information, if said verification was successful.

One advantage of the three aspects mentioned above, is that the user does not need to reveal any personal information about himself to any part of the system. Instead he uses either his persistent or his temporary pseudonym when he is in contact with the system, according to the invention. This ensures that there can be no misuse of vital user information, even if the system is attacked, as no such information is stored or used within the system. Another advantage is that there is no link between the actual user and the information he requests. Hence, the privacy of the user is maintained, as the actual identity of said user is not associated with the identifiers in the system. Consequently, monitoring of the behavior of a user in the information distribution system is prevented. A third advantage is that the information system is more readily accepted by potential users, as it protects the users' privacy. A further advantage is that the security measures taken in conventional information distribution systems, in order to protect stored information related to the actual identity of the user, can be relaxed in a system according to the invention, as there is no database storing vital information about the users.

Below is listed a number of advantages related to different embodiments of the invention. Common for all of these is that the methods described keep the identity of the user secret to the system.

The method of sending said temporary pseudonym as a certificate, as defined in claim 2, has the advantage of providing security to the system and non-repudiation to the accessing device, as the accessing device will check if the certificate is signed by a trusted party.

The method of encrypting said temporary pseudonym with said persistent pseudonym, and creating verification data, using said temporary pseudonym, as defined in claim 3 has the advantage of enabling said accessing device to verify the authenticity of said temporary pseudonym. The encryption and verification data also provides integrity and confidentiality to the user.

The method of generating a license, which is useable to gain access to said requested information, as defined in claims 4 to 9, provides security for the information provider, without revealing the identity of the user to the system.

The method of exchanging certificates between said user identity device and said accessing device, as defined in claim 5, has the advantage of providing security to the information provider.

By managing the license as defined in claim 7 and 9, the user identity device is able to verify that the data sent by the accessing device and identity device is correct.

Some advantages, which are obtained by embodiments of said method, have been described above. Similar advantages can also be achieved by corresponding embodiments of said information distribution system, which comprises said user identity device, as defined in the dependent claims related to the system and the device respectively.

Further, advantageously, if said temporary pseudonym is randomly generated, as defined in claim 8, the pseudonym is created independently of the information distribution system. Consequently, it is not possible to link the randomly generated pseudonym to any other action within the information distribution system.

Advantageously, the persistent pseudonym is a public key, which allows the information distribution system to encrypt information for the user identity device, using said persistent pseudonym. Hence, confidentiality is provided to the system.

Further, advantageously, the user identity device is a smartcard, which facilitates the association of data to the user identity device.

Still further, the accessing of data is, advantageously, performed in accordance with Digital Right Management (DRM) regulations, which provides a protocol for information distribution.

The basic idea behind the invention is that instead of preventing misuse of user information by improving the security around the devices on which the information is stored, the privacy of the user is provided by never using or storing the information in the first place. So, even if the information distribution system is attacked, the attacker will not be able to obtain a complete list of all information accessed by a user. As stated above the user can for example use a permanent pseudonym when requesting information and a temporary pseudonym when later accessing the requested information.

These and other aspects of the invention will be apparent from and elucidated with reference to the embodiments described hereinafter.

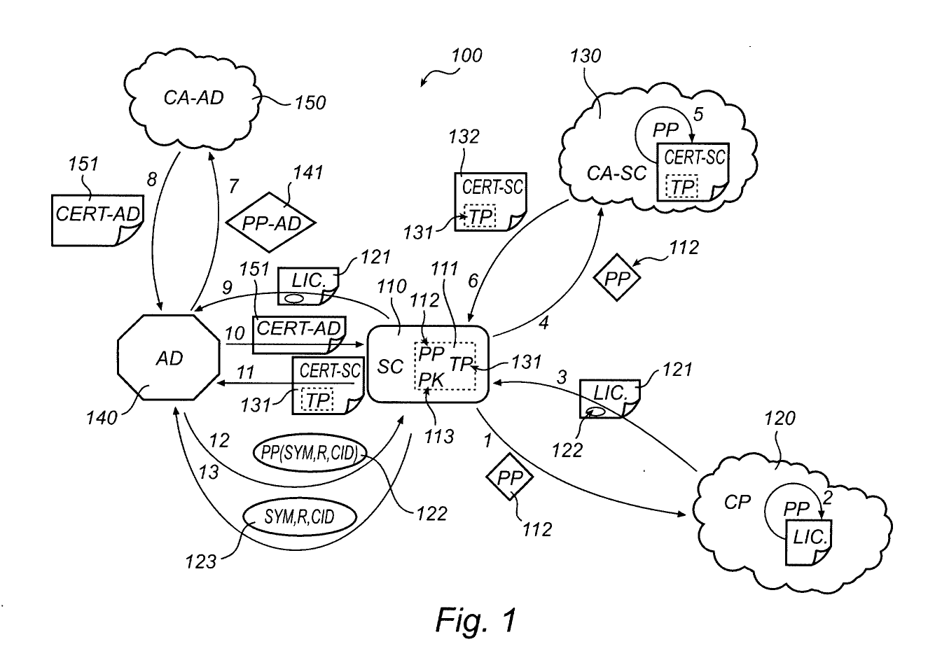

FIG. 1 schematically shows an embodiment of the present invention.

FIG. 1 schematically shows an embodiment of the present invention. A user who wants to access information belonging to a content provider CP 120, such as a data base connected for example to the Internet, without revealing his actual identity to the information system 100, can do so by using a smart card SC 110, which is arranged according to the invention. When the user wants to buy rights to access some content, he contacts the content provider 120 by means of an anonymous channel requesting the rights. After an anonymous payment scheme has been conducted, the user sends 1 his public key PP 112 to the content provider 120, which then creates 2 the right or license 121 for that content. In a preferred embodiment the content is encrypted by the content provider with a symmetric key SYM and sent to the user together with the license 121. Preferably, the format of the license is {PP [SYM//Rights/contentID]}_{signCP}, or {PP [SYM//Rights/contentID], H(Rights), H(contentID)}_{signCP}, where PP encrypts the concatenated values [SYM//Rights/contentID]. Rights describe the rights obtained by the user, for example whether he is entitled to listen to a whole song or just an intro, or the number of times he is entitled to listen to the song. ContentID identifies the content which is associated to said rights, and signCP is the signature of the content provider 120 on the license 121. H( ) in this embodiment is a one-way hash function. The license 121, when inspected, does neither reveal the public key PP 112, nor the content identifier or the rights, so it preserves the user's privacy with respect to content and rights ownership. Therefore, if the license 121 is found in a user's storage device, it does not compromise the user's privacy. During this buying procedure, which has been described above, the content provider 120 learns the association between the public key PP 112 and the contentID, the rights and the symmetric key, but it does not learn the real user's identity due to the anonymous channel.

Typically, in order for a user to securely access content on an accessing device (AD) 140, a compliance certificate 132 for his smart card 110 must be shown to the accessing device 140. This compliance certificate 132 does not contain, however, the public key PP 112, but it is issued with a changeable SC pseudonym or a temporary pseudonym 131. To obtain the compliance certificate 132 for the SC 110, the user/SC contacts the compliance certificate issuer for smart cards (CA-SC) 130 anonymously, sends 4 its public key PP 112 and asks for the certificate 132. Assume that the smart card issuer keeps track of smart cards' behavior by means of a revocation list with the public keys of hacked smart cards 110. The compliance certificate issuer for smart cards (CA-SC) 130 checks with the smart card issuer whether the private key PP 112 belongs to the revocation list or not. If it does not, the compliance certificate issuer for smart cards (CA-SC) 130 then generates 5 a temporary pseudonym 131 for the smart card 110, for example a random number RAN, and issues the following compliance certificate 132, which is sent 6 to the smart card 110: {H(RAN), PP[RAN]}_{signCA-SC}. H( ), in this embodiment, is a one-way hash function, PP 112 encrypts RAN, and signCA-SC is the signature of the CA-SC on the certificate.

The certificate 132, when inspected, does neither reveal the public key PP 112, nor the smart card's 110 temporary pseudonym RAN 131. Moreover, the only entity which can obtain RAN 131 from the certificate 132 is the smart card 110. This is done via decryption with the private key PK 113. The value RAN 131 may then be checked by a verifier via the hash value in the certificate. The use of a pseudonym RAN 131 allows the verifier to check the compliance of the smart card 110, without learning its public key PP 112. Moreover, since the pseudonym RAN 131 can be changed as often as required (every time the smart card SC 110 obtains a new compliance certificate 132), the possibility of a verifier to link compliance certificates to a given smart card 110 can be minimized. During the procedure, which has been described above, the compliance certificate issuer for smart cards (CA-SC) 130 learns the association between the public key 112 and RAN 131, but not the real user's identity due to the anonymous channel.

Now the user can access the content for which he has a license, which can only be performed on an accessing device AD 140. Typically the accessing device 140 behaves in accordance with DRM rules. To access content the user must either carry the content and license with him (e.g. in an optical disk) or have them stored in some location over the network. In either case, the content plus license must first be transferred to the accessing device AD 140. Moreover, since the user is now physically present in front of the accessing device AD 140, his actual identity may be “disclosed” to the AD 140. The accessing device AD 140 can for example be equipped with a camera taking a photograph of the user, which later can be used to trace the identity of the user. There might also be an observer physically present near the accessing device 140. Therefore, in order to prevent the disclosure of the association, between the actual identity of the user and the public key PP, to any other than the user, the public key PP 112 should not be revealed to the accessing device AD 140 at the time of content access. That is the reason why the compliance certificate 132 for the SC 110 is issued with a changeable pseudonym RAN 131. Upon check of that certificate 131, the accessing device 140 learns the RAN, but does not learn the public key PP 112. The content access procedure is described below.

Before the smart card 110 and the accessing device 140 interact with one another, they do a mutual compliance check: compliance of the accessing device AD 140 is proved by means of an accessing device compliance certificate 151, which is issued by the compliance certificate issuer for accessing devices (CA-AD) 150, and which is shown 10 to the smart card 110. In order to be able to verify the accessing device compliance certificate 151, the smart card 110 is provided with a public key of the CA-AD. If this key is changed periodically, that obliges the AD to periodically renew its compliance certificate. This also implies that the smart card SC 110 must renew that key periodically, what can be done at the time that the SC 110 obtains its own compliance certificates from the CA-SC.

Compliance of the smart card 110 is provided by means of the pseudonymous compliance certificate 132, which is shown 10 to the accessing device 140. As mentioned above the smart card 110 obtains the value RAN from the certificate 132, by decrypting it with the private key PK 113, and sends this value to the accessing device 140. The accessing device 140 checks this value via the term H(RAN) in the certificate. Since the accessing device 140 can be provided with a clock, the smart card compliance certificate 132 may have its time of issuance added to it, which obliges the smart card 110 to periodically renew the certificate when it gets too old. It is also in the interest of the smart card to renew its compliance certificate often enough, so as to minimize the linkability mentioned above.

After this mutual compliance check, described above, the accessing device 140 sends 12 the term PP[SYM//Rights/contentID] from the license to the smart card 110, which decrypts it and sends 13 the values 123 SYM, Rights and contentID back to the accessing device 140. The accessing device 140 can then use SYM to decrypt the content and give the user access to it, according to Rights.

During the above described procedure the accessing device learns the association between the RAN and the content, rights and SYM, respectively, and may learn the real user's identity. Therefore, an attacker in control of the accessing device may be able to obtain the real user's identity (e.g. a photo of the user), his SC's temporary pseudonym RAN as well as the specific content which was accessed by the user during that transaction and the accompanying rights. This fact, however, compromises the user's privacy only concerning the specific content and rights involved in that transaction. This type of attack is hard to really avoid. Concerning the value RAN, as it changes often, the user may be tracked but only for a limited number of transactions.

In a second embodiment, which is equal to the above described embodiment except for a few steps. One is that the license further comprises verification data for said Rights and contentID, another that the user identity device by this verification data can verify that the received data has not been tampered with. In this second embodiment the accessing device 140 sends the term PP[SYM//Rights/contentID] from the license together with H(Rights) and H(contentID) to the smart card 110, the smart card decrypts the values in the term PP[SYM//Rights/contentID], encrypts the decrypted values of Rights and contentID with a one-way hashfunction H( ) into H(contentID)′ and H(Rights)′, verifies that H(contentID)′ and H(Rights)′ equals the received H(contentID) and H(Rights), respectively, and sends 13 the values 123 SYM, Rights and contentID 13 the values 123 SYM, Rights and contentID back to the accessing device 140. The verification ensures that the values in the term PP[SYM//Rights/contentID].

As for security requirements of the DRM system, the solution proposes compulsory compliance checks between the smart card and the accessing device upon a content access transaction which still preserve the user's privacy by means of SC's pseudonyms.

The idea behind the invention is that the user obtains the smart card in such a way that the information distribution system can not trace who the user is. This can be achieved for example by letting the user pick his smart card from a pile of identically “looking” cards. In one embodiment each smart card has a different secret public/private key pair PP/PK in it and an un-set PIN. Typically all PINs are initially set to 0000). The SCI guarantees that until the user, or anybody else, interacts with the card for the first time, the public key of that specific card is not revealed to any party, nor is a PIN set. So, the user, as the first interacting party, is the only entity which can learn the public key, and therefore know the association between the actual user and the public pseudonym. The user is also the one who sets the PIN, used to activate the card.

Below follows a short summary of what is known to different parts of the system.

the issuer of the smart card does not know any association of user's identities and content/rights, the CP knows the association between the public key PP 112 and the content, rights and SYM,

the CA-SC knows the association between the public key PP 112 and the temporary key RAN 131,

the accessing device 140 knows the association between the temporary pseudonym RAN 131 and the content, rights and SYM.

Therefore, even by a collusion of the content provider CP 120, the CA-SC 130 and the accessing device 140, the actual identity of the user can not be revealed since only the user knows the association between the actual identity of the user and the public key PP 112. Furthermore, if an attacker is able to obtain user related information from the accessing device 140, after a content access transaction has occurred, the association between the actual identity of the user and the temporary pseudonym, as well as the associations between the actual identity of the user and the content, Rights and SYM, respectively, becomes known to him. However, since the temporary pseudonym RAN 131 changes periodically and only one piece of content is associated with the user's real identity, the privacy damage is minimal. As the attacker can not learn the user's public key PP 112 from the accessing device, he can not create a full log of the user's ownership of content and pattern of content usage.

Consequently, as described above, the present invention presents anonymous purchasing of content and rights as well as anonymous checking rights and access to content, in such a way that none of the individual parties in the system is able to, either individual or together, learn the real identity of the user. It is to be noted, that for the purposes of this application, and in particular with regard to the appended claims, the word “comprising” does not exclude other elements or steps, that the word “a” or “an”, does not exclude a plurality, that a single processor or unit may perform the functions of several means, and that at least some of the means can be implemented in either hardware or software, which per se will be apparent to a person skilled in the art.

1. A method for keeping the identity of a user secret, comprising:
requesting information from an information distributing device in the name of a persistent pseudonym, which is associated to a user identity device;
transmitting data representing said persistent pseudonym to an identity managing device;
verifying, at said identity managing device, said data to ensure that said persistent pseudonym is trusted;
creating at least one temporary pseudonym;
sending said at least one temporary pseudonym to said user identity device upon a successful verification; and
representing (11) said user by said at least one temporary pseudonym, when accessing said requested information.

2. A method according to claim 1, wherein the method further comprises:
receiving, at said identity managing device, said persistent pseudonym and a request for a compliance certificate from said user identity device; and,
if said persistent pseudonym is considered to be trusted, generating said compliance certificate, which includes said temporary pseudonym;
and wherein said step of sending at least one temporary pseudonym to said user identity device comprises sending said compliance certificate to said user identity device.

3. A method according to claim 2, wherein said generating said certificate further comprises:
encrypting, at said identity managing device, said temporary pseudonym using said persistent pseudonym;
creating verification data, using said temporary pseudonym, which verification data is useable by said user identity device when verifying said decryption of said encrypted temporary pseudonym; and
including both said encrypted temporary pseudonym and said verification data in said compliance certificate.

4. A method according to claim 1, further comprising:
generating, upon reception of said request for information at said information distributing device, a license for said requested information;
sending said license to said user identity device, encrypting said requested information and sending it to information storage means.

5. A method according to claim 4, further comprising:
obtaining, at an accessing device, said license and said encrypted information;
exchanging compliance certificates between said accessing device and said user identity device, wherein said user is represented by said temporary pseudonym, and performing mutual verifications of said certificates;
providing, upon successful verifications of said certificates, said user identity device with access to said information.

6. A method according to claim 4, further comprising:
using a symmetric key when encrypting said requested information;
using said persistent pseudonym when encrypting values representing said symmetric key, rights associated with said persistent pseudonym and an identifier of said requested information; and
generating said license containing said encryption.

7. A method according to claim 6, further comprising:
using a first hash function to create a first set of data representing an encrypted value of said rights associated with said persistent pseudonym;
using said first hash function to create second set of data representing an encrypted value of said identifier of said requested information; and
including said first and second set of data in said license.

8. A method according to claim 6, wherein said providing the user access to said requested information further comprises:
verifying, at said accessing device, said license;
sending said encryption, contained in said license, from said accessing device to said user identity device;
decrypting, using a private key, at said user identity device, said encryption received from said accessing device into values representing said symmetric key, said rights associated with said persistent pseudonym and said identifier of said requested information;
sending, from said user identity device, said decrypted values to said accessing device,
decrypting, at said accessing device, said encrypted requested information using said symmetric key, being received from said user identity device;
providing, at said accessing device, said user access to said requested information in accordance to said rights received from said user identity device.

9. A method according to claim 8, wherein said decrypting said encryption, received from said accessing device into values representing said symmetric key, said rights associated with said persistent pseudonym and said identifier of said requested information, further comprises:
obtaining said first and second set of data from said license,
encrypting, by said first hash function, said decrypted value representing said rights associated with said persistent pseudonym;
encrypting, by said first hash function, said identifier of said requested information; and
verifying said decrypted values by comparing said first set of data to said encrypted value of said rights and comparing said second set of data to said encrypted value of said identifier.

10. A method according to claim 1, wherein said temporary pseudonym is randomly generated.

11. A method according to claim 1, wherein said accessing is performed in accordance with Digital Right Management regulations.

12. A user identity device for use in an information distribution system where the identity of a user is kept secret, comprising:
a persistent pseudonym,
means arranged to receive and store a temporary pseudonym,
means arranged to send said persistent pseudonym to an identity managing device of said information distribution system, and
means arranged to send said temporary pseudonym to an accessing device of said information distribution system.

13. A user identity device according to claim 12, wherein said means, arranged to receive a temporary pseudonym, is further arranged to receive a compliance certificate comprising an encryption of said temporary pseudonym by said persistent pseudonym and verification data usable for verification of said temporary pseudonym.

14. A user identity device according to claim 12, further comprising:
means arranged to receive and store a license from an information distributing device in said information distribution system, said license comprising encrypted values representing a symmetric key, rights associated with said persistent pseudonym and an identifier of said requested information; and
means arranged to provide said license to said accessing device.

15. A user identity device according to claim 12, further comprising:
means arranged to receive, from said accessing device, encrypted values representing a symmetric key, rights associated with said persistent pseudonym and an identifier of said requested information;
means arranged to decrypt said encrypted values; and
means arranged to send said decrypted values, representing said symmetric key, said rights associated with said persistent pseudonym and said identifier of said requested information, to said accessing device.

16. A user identity device according to claim 15, wherein said user identity device is further arranged to receive a first and a second set of data, which is encoded by a hash function, respectively, and to verify said decrypted values, by comparing to said first and second set of data.

17. A user identity device according to claim 12, further comprising information storage means arranged to receive and store information from said information distributing device, and to provide said information to said accessing device.

18. A user identity device according to claim 12, wherein said temporary pseudonym is a random number.

19. A user identity device according to claim 12, wherein said persistent pseudonym is a public key.

20. An information distribution system for keeping the identity of a user secret, comprising:
an information distributing device, comprising information which is requested by said user;
a user identity device;
an identity managing device, arranged to receive data representing a persistent pseudonym, being associated with said user identity device, to verify that said persistent pseudonym is trusted, and to create a temporary pseudonym upon a successful verification;
means for associating data representing said temporary pseudonym with said user identity device;
an accessing device, arranged to receive said data representing said temporary pseudonym, and further to provide said user access to said requested information upon a successful verification.

21. A system according to claim 20, wherein:
said identity managing device is arranged to encrypt said temporary pseudonym using said persistent pseudonym, to create verification data, using said temporary pseudonym, which verification data is usable by said user identity device when verifying a decryption of said encrypted temporary pseudonym, and to include both said encrypted temporary pseudonym and said verification data in a compliance certificate.

22. A system according to claim 20, wherein:
said information distribution system comprises information storage means arranged to receive encrypted information from said information distributing device; and
said information distributing device is arranged to generate a license for said requested information, to send said license to said user identity device to encrypt said requested information and to send it to said information storage means.

23. A system according to claim 22, wherein:
said accessing device is arranged to receive and store said license, receive said encrypted information, and to verify said received compliance certificate from said user identity device;
said user identity device is arranged to verify a certificate from said accessing device; and
said accessing device is arranged to, upon successful verification of said certificates, provide said user with access to said requested information.

24. A system according to claim 23, wherein:
said information distributing device is further arranged to encrypt said requested information using a symmetric key, into values representing said symmetric key, rights associated with said persistent pseudonym and an identifier of said requested information, and to include said encrypted values in said license.

25. A system according to claim 24, wherein:
said accessing device is arranged to verify said license and to send said encryption, contained in said license, to said user identity device;
said accessing device is further arranged to decrypt said encrypted requested information, using said symmetric key received from said user identity device and to provide said user access to said requested information in accordance with said rights received from said user identity device.

26. A system according to claim 20, wherein said accessing device is arranged according to Digital Rights Management regulations.
